(19) United States
(12) Patent Application Publication
(10) Pub. No.: US 2006/0017198 A1
(43) Pub. Date: Jan. 26, 2006

(54) Craft kit for making toy figures

(76) Inventor: Stephen A. Koehl, Newport Beach, CA (US)

Correspondence Address: Harold L. Jackson;Jackson Law Corporation, Ste. N, 14751 Plaza Dr., Tustin, CA, 92780, US

(21) Appl. No.: 10/898,138

(22) Filed: Jul. 22, 2004

(51) Int. Cl. B29C 43/36

(52) U.S. Cl. 264/319; 425/DIG. 57; 425/318

(57) ABSTRACT

Molding arrangements and process are disclosed that provide simple yet reliable techniques for making cast product. A mold tray having a cavity of a desired shape for a cast product may be placed on a surface and mold material added to the mold cavity. A cover may be placed on the mold tray covering the mold cavity and pressure may be applied thereto to urge the mold material into the cavity.

### FIELD OF THE INVENTION

The invention relates generally to the making of toy figures, such as miniature cars and trucks, and more particularly to a mold craft kit allowing a child to create toy figures and to decorate these figures and add other features.

### BACKGROUND OF THE INVENTION

Craft kits for children are universally popular with children and parents. They enable children with little artistic skills to create toys and other play items or even artwork such as pictures and drawings. Furthermore, crafts kits that involve little or no adult assistance or supervision are very desirable for both children and their parents. Making their own toys also allows for more imaginative play by children which is desired by adults these days. As such many craft kits have been developed and are available today that allow children to create items with little or no skills.

One well known method for forming shaped figures that has been available in craft kits includes two side by side half mold sections each half mold section having about half the shape of the figure. Each mold section has interlocking edges along the extent of the mold section that allow the two half mold sections to be mated together. The mold sections when mated are held together by four to five clips. When the two half mold sections are mated they together form an opening for receiving mold material. The mold is turned upside down and a child may simply add mold material into the mold through the opening and allow the mold material to cure. After the mold material cures, the clips are removed and the two mold section pulled apart providing the molded figurine product.

Many prior art toy craft kits have various attractions. However, there is always a demand for new toys and craft kits that may offer different features and advantages from those in the art. Accordingly, improvements are continually being made in this art as with any other field as part of any business or market and craft kits for children with minimal skills are continually being sought and developed.

### SUMMARY OF THE INVENTION

The present invention provides another improved craft kit arrangement for molding products useable by children without any special training or skill. The invention in one aspect provides a mold arrangement for making cast products that includes a mold portion having a cavity defining a desired shape. The cavity shape can be designed to form a variety of molded products, including toy products, such as cars or trucks, for example. A top mold portion is included in the mold arrangement for placement over the cavity of the mold portion. The top mold portion has one or more mold shapes that add additional shaped features to the molded product. Additionally, the top mold portion and the mold portion may have cooperative structures for aligning the top mold portion over the cavity of the mold portion.

The mold portion and its top mold portion may be made of a suitable plastic material; one such material could be a thin gauge plastic. It is desirable that the top mold portion be flexible to facilitate a preferred molding process. The plastic material may also be transparent allowing viewing of the product during the molding process. The mold portion may include a stand member. The stand member may take the form of a plurality of legs that allow the mold portion to be placed on a surface such as a table.

A process for molding products may include the steps providing a mold defining a cavity and providing a top mold portion for covering the cavity which top mold portion defines another cavity; putting a mold material into the mold cavity and placing the top mold portion on the mold portion wherein the mold cavity and the top mold portion cavity define the shape of the product. The top mold portion may be rolled onto the mold portion and over the cavity to remove air bubbles. The mold portion may be placed on a vertically oriented surface to facilitate this process. Also, an object may be placed on the top mold portion to apply pressure to it and hold it in place while the mold material is curing.

The construction and operation of preferred embodiments of such above-described mold and methodology may best be understood by reference to the following description taken in conjunction with the accompanying drawings in which like components are designated by the same reference numbers.

### BRIEF DESCRIPTION OF DRAWINGS

FIG. 1 is a top view of a mold section for casting parts according to one embodiment of the present invention;

FIG. 2 is a side view of the mold section of FIG. 1;

FIG. 3 is a top view of a cover for the mold section of FIG. 1;

FIG. 4 is a side view of the cover of FIG. 3;

FIG. 5 is a perspective view of the mold section according to one process for molding products;

FIG. 6 is a perspective view of the mold section with mold material being added into the mold section's cavity;

FIG. 7 is a perspective view of the mold section and its cover with mold material filling the mold section's cavity;

FIG. 8 is a side view of the mold section showing the cover being rolled onto the mold section;

FIG. 9 is a perspective view of the mold section with the cover in place; and

FIG. 10 is a perspective view of the mold section and cover with an object placed on the cover.

### DESCRIPTION OF PREFERRED EMBODIMENTS

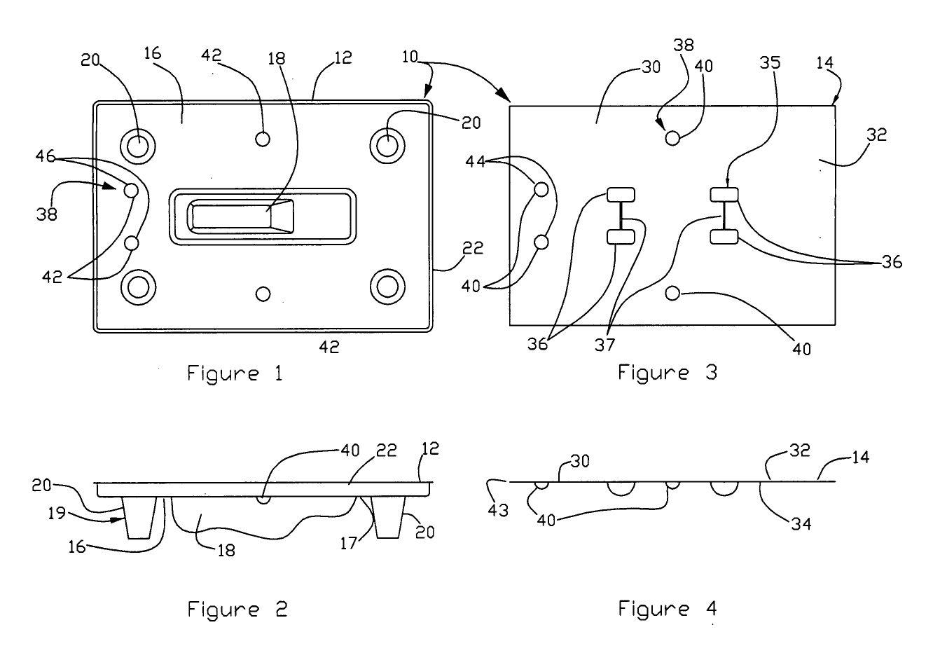

Referring now to the drawings and in particular to FIGS. 1 through 4, there is shown a preferred embodiment of the mold apparatus 10 including a bottom mold section or portion 12 illustrated in FIGS. 1 and 2, and a top mold section or portion 14 illustrated in FIGS. 3 and 4. The bottom mold portion 12 has a flat section 16 with a cavity 18 therein. The cavity 18 extends downwardly from the flat section 16 and defines a shape, such as a car or truck or other desired shape for the product to be molded or cast. The bottom mold section 12 may also include a stand member or support structure 19 for placing the mold on a vertically oriented surface such as a table top. In this particular embodiment, the stand member 19 takes the form of four legs 20 which extend downwardly from the mold flat section 16. The bottom mold section 12 may thus be conveniently placed on a table or the like (not shown) with the cavity extending downwardly for ease in placing a molding material into the cavity. The bottom of the mold cavity could be even with the stand or legs to provide another stand area. The bottom mold portion 12 may further include an upstanding circumferential side 22 which defines the lateral extend of the bottom mold portion. The bottom mold portion may be made of a variety of materials including plastic material and may be a thin gauge plastic material on the order of 12 gauge, for example.

The top mold portion 14 may comprise a flat section 30 having a top surface 32 and a bottom surface 34. The flat section 30 of the top mold portion may be sized to fit within the upstanding circumferential side 22 of the bottom mold portion 12. The top mold portion 14 may include one or more mold shapes generally designated be reference number 35. More specifically, in this illustrated example of a molded product being a car or truck, four mold features 36 extend out from the bottom surface 34 of the top mold portion 14, which are shaped as wheel wells and provide the car or truck body to be formed by the bottom mold portion cavity with wheel wells. Also in the top mold portion illustrated small axel depressions 37 connect the wheel wells, which axel depressions may each receive a wheel axel to be mounted to the vehicle after molding. Of course while wheel wells and axel depressions are illustrated in this example, a variety of desired shapes can be incorporated into the top mold portion. Accordingly, the top mold portion 14 may advantageously contain mold shapes that cooperate with the bottom mold cavity to form a desired cast product. The mold shapes could also be shaped to form attachment structures to the molded product such as holes for plugs or screws. Also, the mold features in the cover could extend upwardly to provide additional or alternative shaped features to the molded product. The top mold portion can be used with other mold arrangements not shown here but contemplated by this invention. The top mold portion may be made of a variety of materials including plastic material and may be a thin gauge plastic material on the order of 12 gauge, for example.

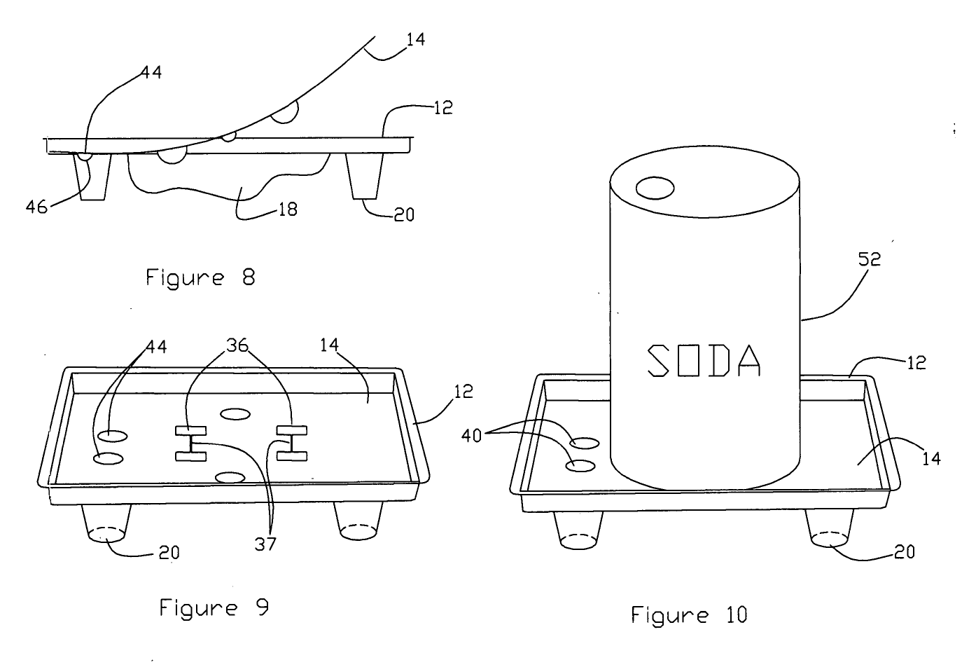

Each of the top mold portion and the bottom mold portion may have cooperative locating structures generally designated by reference number 38 for aligning the top mold portion on the bottom mold portion. In this preferred embodiment, the top and bottom mold portions contain bubble portions 40, the top mold portion 14 having four bubble portions 40 spaced around flat section 30 protruding out from bottom surface 34, and the bottom mold portion 12 also having four bubble portions 42 spaced around flat section 16 protruding out from bottom surface 17. When locating the top mold portion onto the bottom mold portion, the bubble portions 40 from the top mold portion seat into the bubble portions 42 of the bottom mold section (see for example FIG. 8). While many other aligning mechanisms or cooperative locating structures are contemplated by the invention, the bubble portions are easy and simple to form into the two mold portions and thus illustrate a preferred additional feature in this description. The bottom mold portion and top mold portion may be transparent allowing viewing of the product during molding.

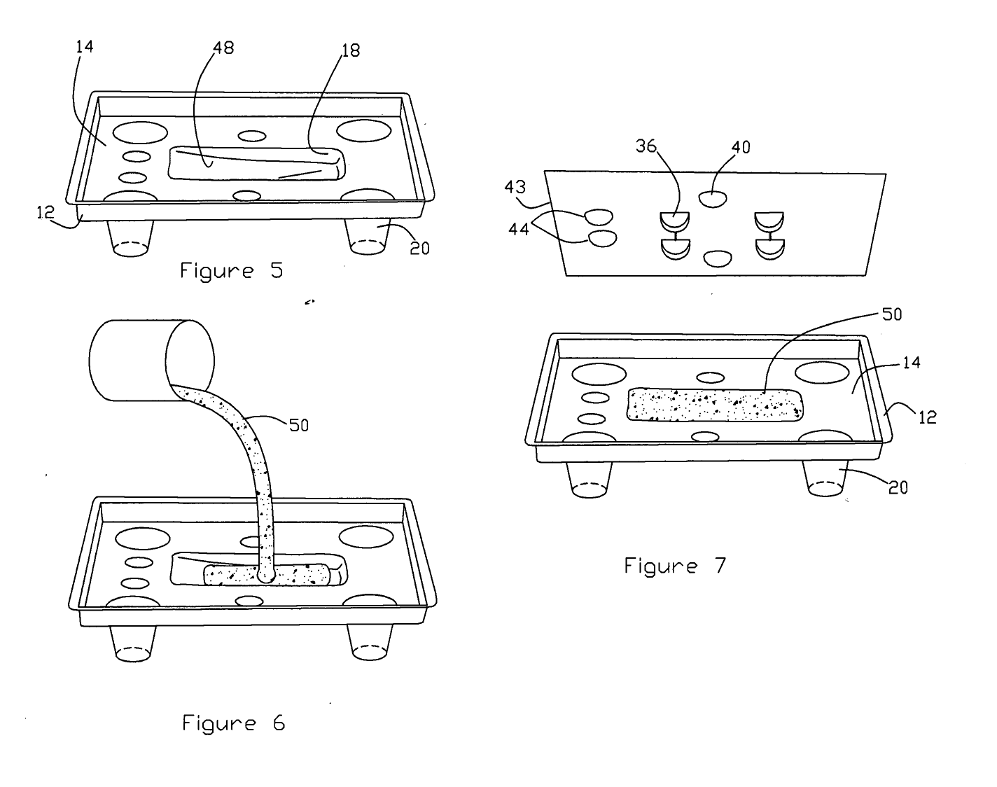

In a preferred process for making products as illustrated in FIGS. 5 through 10, bottom mold portion 12 is provided and may be placed on a planar surface such a table top (not shown) using the legs 20. While the legs 20 provide an additional feature for the preferred embodiment of the bottom mold portion, they add a convenience feature for the molding process enabling the bottom mold portion to serve as a tray, see FIGS. 5 and 6 for example. Mold material 50 is placed into the cavity 18 of the bottom mold portion 12, see FIG. 6. A preferred mold material is known as PerfectCast™ may be used to make the product. The mold material 50 may be added to fill the entire cavity as shown in FIG. 7. The top mold portion 14 is placed on the bottom mold portion 16, preferably by starting with one end of the top mold portion and bending and pushing the top mold portion onto the bottom mold portion 12 as illustrated in FIG. 8. More specifically, desirably locate the bubble portions 40 at one end 43 of the top mold portion, such as bubble portions or indentations 44 into the receiving bubble portions or indentation 46 of bottom mold portion and slowly push along the lateral extent of the top mold section to essentially roll the top mold portion onto the bottom mold portion. The rolling of the top mold portion onto the bottom mold portion and over the cavity pushes air bubbles out from between the two portions that could get trapped therebetween. The top mold portion 14 when in place serves as a cover or lid for the cavity in the bottom mold portion 12, see FIG. 9. This cover 14 may also be used to urge the mold material 50 into and against the inner wall 48 of the cavity. An object 52 serving as a weight may be placed onto the top mold portion 14 or cover for applying pressure to the cover thereby keeping it against the bottom mold portion 12. The cover accordingly may assist in compacting the mold material into the cavity 18 improving the reliability of producing a more complete product. In this example, a soda can is shown as the object providing the weight.

Upon curing or drying the mold material has taken the shape of the mold cavity 18 and any features in the cover 14, and the finished product may be removed from the bottom mold portion 12. The top mold portion is removed preferably by peeling it off the molded product. To facilitate removal of the product from the bottom mold portion, the bottom mold portion may be turned upside down and even gently tapped if required. After removal, additional items may be added to the molded figure. In this example of a car or truck, tires with axels may be added. Additionally, the figure may be painted and decaled.

There has thus been described an improved molding apparatus and method providing a simple yet reliable technique for molding a variety of products including for example toys by young adults. While cars and trucks have been illustrated, figures such as action figures, bugs or animals are possible as well as many other products. Various modifications to the molding apparatus and method will occur to person skilled in the art without involving any departure from the spirit and scope of the invention as set forth in the appended claims.

What is claimed is:

1. A mold apparatus for making products, comprising:
a bottom mold portion having a cavity defining a desired shape for the product; and
a top mold portion wherein the top mold portion has at least one shaped feature such that when the top mold portion is placed on the bottom mold portion the at least one shaped feature further defines the shape of the product.

2. The mold apparatus of claim 1 wherein the top mold portion has a flat portion and the bottom mold portion has a corresponding flat portion surrounding the cavity.

3. The mold of claim 2 wherein the bottom mold portion and top mold portion have cooperative indentations for aligning the top mold portion shaped feature over the cavity.

4. The mold apparatus of claim 1 wherein the bottom mold portion includes at least one stand member.

5. The mold apparatus of claim 4 wherein the at least one stand member comprises four legs.

6. The mold apparatus of claim 2 wherein the bottom mold portion includes a circumscribing upstanding edge.

7. The mold apparatus of claim 1 wherein the top mold portion is made of plastic material.

8. The mold apparatus of claim 7 wherein the mold top is made ofthin gauge plastic material such that the top mold portion is bendable.

9. The mold of claim 1 wherein the mold bottom portion cavity defines the shape of a vehicle and the top mold portion at least one shaped feature defines the shape of wheel wells.

10. A mold assembly for making cast products, comprising:
a bottom portion having a downwardly extending cavity having a defined shape for receiving mold material; and
a top portion having a flat section for seating on top of the bottom portion, the top portion having a defined shaped cavity which overlies the bottom portion cavity and receives mold material therein to further define the shape of the cast product.

11. The mold assembly of claim 10 wherein the top portion defined shape cavity overlies and extends into the bottom portion cavity to displace mold material therein to further define the shape of the cast product.

12. The mold assembly of claim 10 wherein the top portion defined shape cavity overlies the bottom portion cavity having portions that extend into the bottom portion cavity and portions that extend out from the bottom portion cavity to further define the shape of the cast product.

13. The mold assembly of claim 111 wherein the bottom portion cavity and top portion defined shape define the shape of a vehicle having wheel wells.

14. The mold assembly of claim 10 wherein the bottom portion has a stand such that the bottom portion can be placed on a surface with the bottom cavity portion extending downwardly.

15. The mold assembly of claim 10 wherein the top and bottom portions have cooperative bumps for aligning the top and bottom portions.

16. A molding process for making a product, comprising the steps of:
providing a mold defining a cavity;
providing a lid for the cavity, the lid defining another cavity;
putting mold material into the cavity of the mold; and
placing the lid over the mold cavity wherein the mold cavity and lid cavity define the shape of the product.

17. The molding process of claim 16 wherein the step of placing the lid over the mold cavity comprising rolling the lid on the mold over the cavity.

18. The molding process of claim 17 further comprising the step of applying pressure on the lid to push the mold material into the mold cavity.

19. The molding process of claim 18 wherein the step of applying pressure comprises placing a weighted object onto the lid.

20. The molding process of claim 18 further comprising the steps of removing the molded product from the mold cavity and the lid and painting the molded product.
